(19) United States
(12) Patent Application Publication
(10) Pub. No.: US 2022/0077512 A1
(43) Pub. Date: Mar. 10, 2022

(54) BATTERY FOR A MOTOR VEHICLE, MOTOR VEHICLE AND METHOD FOR CHARGING A BATTERY

(71) Applicant: HELLA GmbH & Co. KGaA, Lippstadt (DE)

(72) Inventors: Jens GERLING, Ense (DE); Olaf WINKLER, Lippstadt (DE)

(73) Assignee: HELLA GmbH & Co. KGaA, Lippstadt (DE)

(21) Appl. No.: 17/526,583

(22) Filed: Nov. 15, 2021

Related U.S. Application Data
(63) Continuation of application No. PCT/EP2020/061125, filed on Apr. 22, 2020.

(30) Foreign Application Priority Data
May 14, 2019 (DE) 10 2019 112 552.9

(51) Int. Cl. H01M 10/44; H01M 50/249; H01M 50/204; H01M 10/625; H01M 10/653; H01M 4/485; H01M 4/505; H01M 4/525; H01M 4/58; H01M 10/0525; H01M 10/42; H01M 16/00; H02J 7/00; B60R 16/033

(52) U.S. Cl. CPC H01M 10/441; H01M 2010/4271; H01M 50/204; H01M 10/625; H01M 10/653; H01M 4/485; H01M 4/505; H01M 4/525; H01M 4/5825; H01M 10/0525; H01M 10/4257; H01M 10/443; H01M 16/00; H02J 7/0047; H02J 7/007194; B60R 16/033; H01M 2220/20; H01M 50/249

(57) ABSTRACT

A battery for a motor vehicle, having a plurality of a first battery cells of a first type of material and a plurality of second battery cells of a second type of material which is different from the first type of material, wherein the first battery cells are electrically interconnected with one another for charging and discharging independently of the second battery cells, and the second battery cells are electrically interconnected with one another, and wherein in each case one of the plurality of first battery cells is arranged next to in each case one of the plurality of second battery cells in a first mounting plane. The invention further relates to a motor vehicle comprising a battery of this kind and to a method for charging and discharging a battery of this kind.

This nonprovisional application is a continuation of International Application No. PCT/EP2020/061125, which was filed on Apr. 22, 2020, and which claims priority to German Patent Application No. 10 2019 112 552.9, which was filed in Germany on May 14, 2019, and which are both herein incorporated by reference.

### BACKGROUND OF THE INVENTION

### Field of the Invention

The present invention relates to a battery for a motor vehicle, a motor vehicle including a battery of this type, and a method for charging a battery for a motor vehicle.

### Description of the Background Art

Different material types, such as Li-ion, NiMH and Pb, may be used in battery cells of a battery. Among other things, the properties, such as capacity, nominal voltage, chargeability and temperature dependencies of these variables of the battery cell, depend on the material type. In motor vehicles, batteries must also be operable and chargeable at temperatures in the range from −40° C. to 60° C. This applies, in particular, to starter batteries or vehicle electrical system batteries, which, unlike traction batteries of motor vehicles, usually do not have separate active heating and cooling systems. Correspondingly, the batteries used must be thermally suitable in the direction of warmer temperatures (for example, above 20° C.) as well as in the direction of colder temperatures (for example, below 0° C.). One requirement of batteries of this type is, for example, that they must be able to be charged and discharged without danger and free of damage at cold ambient temperatures as well as warm ambient temperatures or warm temperatures of the battery cells of the battery. For example, material types for battery cells are known, which may be operated and charged to the greatest extent without danger even at high temperatures. Cold-chargeable material types of battery cells are also known, which may be charged to the greatest extent without danger and free of damage at cold temperatures, using a high charging current. Such thermally advantageous material types are very expensive, in particular if they have otherwise good properties in the battery cells, such as a high capacity and nominal voltage, and are therefore uneconomically, in particular in the automotive field, where large quantities of high-capacity batteries are needed.

### SUMMARY OF THE INVENTION

It is therefore an object of the present invention to mitigate the disadvantages known from the prior art. In particular, the object of the invention is to provide a battery, a motor vehicle including a battery of this type, and a method for charging a battery, which have thermally advantageous properties and are nevertheless economical.

According to an example, the invention achieves the object by means of a battery, in particular a secondary battery or an accumulator, for a motor vehicle, including at least two first battery cells of a first material type and at least two second battery cells of a second material type, which differs from the first material type, the first battery cells being electrically connected to each other for charging independently of the second battery cells, and the second battery cells being electrically connected to each other, and one of the multiple first battery cells being arranged in each case next to one of the multiple second battery cells in a first mounting plane.

Battery cells of different material types are used in a battery, the battery cells of different material types being arranged next to each other. The purpose thereof is that the first and second battery cells also have thermal properties which differ from each other and which may have a favorable effect on the other battery cells in each case during independent charging and/or discharging of the first battery cells or second battery cells. A compensation of the thermal properties and simultaneous economic feasibility of the battery are achieved thereby, since not all battery cells must be expensive battery cells having thermally advantageous properties.

Although the invention relates, in particular, to the field of application and suitability in motor vehicles, further fields of application and suitabilities in other technological fields are, however, possible and provided. For example, the battery according to the invention may also be used in electronic devices such as smart phones and notebook computers as well as rail vehicles, scooters, motorcycles, bicycles, drones and aircraft.

The type of material relates to the materials used in the battery cell. Examples of material types which may be used are Li-ion (lithium ion), NiMH (nickel metal hydride) and Pb (lead). Specific material types of Li-ion or subclasses of the Li-ion type, are, for example, LiCoO₂(lithium cobalt oxide), LiPo (lithium polymer), LiMn (lithium manganese), NMC (lithium nickel manganese cobalt oxide), LiFePO₄ (lithium iron phosphate, also LFP) and Li₄Ti₅O₁₂ (lithium titanate, also LTO). In particular, the battery is a lithium ion accumulator, the first material type and/or the second material type being of an Li-ion type.

In particular, the second battery cells are also electrically connected to each other for charging independently of the first battery cells. A charge control unit may be connected to the first battery cells and/or the second battery cells, so that independent charging is made possible.

The battery cells are arranged or mounted on the mounting plane. The mounting plane may be, in particular, a mounting surface, so that the battery cells of a mounting plane are all arranged or mounted on the same mounting surface. The mounting plane or mounting surface may be formed, for example, by a battery housing of the battery, in particular a wall of a battery housing or a mounting plate in a battery housing.

In particular, each or multiple first battery cells may each be arranged next to one of the multiple second battery cells in the first mounting plane. In particular, a first battery cell in each case may be arranged alternately next to a second battery cell. In this case, a first battery cell is arranged next to a second battery cell in the first mounting plane, and a further first battery cell is arranged next to the second battery cell, next to which, in turn, a second battery cell is arranged. In other words, this may be a sandwich structure, in which first battery cells are alternately arranged next to second battery cells. However, it is also possible that, for example, two or more first battery cells are arranged next to each other and are surrounded by second battery cells, or, for example, two or more second battery cells are arranged next to each other and are surrounded by first battery cells. This arrangement improves a heat transfer between the first battery cells arranged next to each other and/or one after the other and/or one above the other and the second battery cells.

The first battery cells and/or the second battery cells may be provided with different designs and different sizes. For example, the first battery cells and/or the second battery cells may be pouch cells, cylindrical cells or prismatic cells. For example, metal housings, in particular rigid metal housings, and/or flexible composite films may be used as battery cell housings of the first battery cells and/or the second battery cells. The composite films may have multiple material layers, for example one made from metal, for example aluminum, and from plastic.

In each case, one of the multiple first battery cells is preferably arranged next to one of the multiple second battery cells in at least one second mounting plane, one of the multiple first battery cells of the first mounting plane being arranged in each case next to one of the multiple second battery cells of the second mounting plane, and one of the multiple second battery cells of the first mounting plane being arranged in each case next to one of the multiple first battery cells of the second mounting plane. The at least one second mounting plane is, in particular, a mounting plane which is in parallel to the first mounting plane. In particular, the second mounting plane is arranged above or below the first mounting plane. Accordingly, a stack of first battery cells and second battery cells results, each of the first battery cells being arranged next to at least two of the second battery cells, and each of the second battery cells being arranged next to at least two of the first battery cells. In addition, further mounting planes having first battery cells and second battery cells arranged according to the invention may be present, such as a third mounting plane arranged in parallel to the first and second mounting planes. The use of the thermal surfaces of the battery cells is improved thereby.

Battery cell housings of the first battery cells and second battery cells arranged next to each other are further preferably connected to each other. The connection may be, in particular, an immediate, or in other words, direct connection of the battery cell housings to each other. Alternatively, the battery cell housings of the first battery cells and second battery cells arranged next to each other may be connected to each other by a heat transfer medium, such as air or a cooling fluid. The air or cooling fluid may be a heat transfer medium in an active or passive heating system and/or cooling system of the battery. This improves the heat transfer between the first battery cells and second battery cells arranged next to each other.

The battery cell housings of the first battery cells and second battery cells can be arranged next to each other are connected to each other with the aid of a heat conducting element. The heat conducting element may be, for example, a thermally conductive plate, in particular made from a metal, a thermally conductive paste, a thermally conductive pad or a combination thereof. This also improves the heat transfer between the first battery cells and second battery cells arranged next to each other.

It is also possible to connect the first battery cells separately from the second battery cells. This makes it easily possible to be able to charge the first battery cells independently of the second battery cells and the second battery cells independently of the first battery cells. The first battery cells may be connected to each other in series or in parallel. The second battery cells may be connected to each other in series or in parallel. For example, conductor rails may be used as connecting elements.

The battery can be a dual-voltage battery. A dual-voltage battery is connected in such a way that it may be charged and/or discharged with two voltages. The switchover between the two voltages may take place via a control unit of the dual-voltage battery. A first voltage of the two voltages is preferably a 12 V voltage, and a second voltage of the two voltages is preferably a 48 V voltage. In particular, the charge control unit may be configured to charge the dual-voltage battery at 48 V and to discharge the dual-voltage battery at 12 V. The 12 V voltage may be a discharge voltage or vehicle electrical system voltage, in particular of the motor vehicle. The 48 V voltage may be a charging voltage, which is supplied, for example, by an (electric) generator of the motor vehicle.

The first battery cells may be cold-chargeable; in particular, the first material type is lithium titanate. Cold-chargeability means, for example, that a battery cell may be charged at temperatures, for example, below 0° C. without the battery cell being damaged, for example losing capacity or gaining inner resistance. This makes it possible to charge the first battery cells at cold temperatures, so that the battery may be charged at cold temperatures.

The second battery cells are furthermore preferably not cold-chargeable; in particular, the second material type is lithium iron phosphate or lithium nickel manganese cobalt oxide. The second battery cells at least have a poorer cold-chargeability than the first battery cells. In particular, battery cells having a cost-effective material type have this poorer cold-chargeability.

The battery can include at least one second temperature sensor for determining an actual temperature of at least one second battery cell to be charged of the multiple second battery cells, and the battery further includes a charge control unit, which is configured to: (a) determine or predefine a setpoint temperature of the at least one second battery cell to be charged for starting a charging process or increasing a charging current in a charging process of the at least one second battery cell to be charged; (b) receive the actual temperature of the at least one second battery cell to be charged from the second temperature sensor; (c) charge at least one of the multiple first battery cells, which are arranged next to the at least one second battery cell to be charged, the at least one second battery cell to be charged being heated with the aid of the waste heat of the at least one charging first battery cell, which is generated during charging; and (d) start or increase the charging process or the charging current of the charging process of the at least one second battery cell to be charged as soon as the actual temperature of the at least one second battery cell to be charged has reached the setpoint temperature. In particular, each of the second battery cells may include a second temperature sensor.

This achieves the fact that the first battery cells having, in particular, good cold-chargeabilities are charged at cold temperatures below the setpoint temperature and heat the second battery cells having, in particular, poor cold-chargeabilities, which are arranged next thereto, using the generated waste heat. The setpoint temperature is, in particular, determined in such a way that a damage to the second battery cells is avoided. In particular, the setpoint temperature is at least at or above 0° C. The setpoint temperature may be determined as a function of different factors, such as state of charge and/or capacity of the battery cells and/or ambient temperature, or it may be a permanently predefined value for the second battery cells. The second temperature sensor may be configured to ascertain the actual temperature of the at least one second battery cell continuous or at defined time intervals. Correspondingly, the control unit may be configured to receive the actual temperature continuously or at defined time intervals.

The battery can further include at least one first temperature sensor for determining an actual temperature of at least one first battery cell of the multiple first battery cells, and the charge control unit, which is further configured to: (a) determine and predefine a limiting temperature during the operation of at least one first battery cell for blocking or aborting an operation or reducing a current during an operation of at least one second battery cell, which is arranged next to the at least one first battery cell; (b) receive the actual temperature of the at least one first battery cell from the first temperature sensor; (c) operate the at least one first battery cell, which is arranged next to at least one second battery cell, the at least one second battery cell being heated with the aid of a waste heat of at least one first battery cell, which is generated during operation; and (d) to block, abort or reduce the operation or current during the operation of the at least one second battery cell when an actual temperature of the at least one first battery cell reaches the limiting temperature. The operation may be a charging process or a discharging process. The current is correspondingly a charging current during a charging process or a discharging current during a discharging process. In particular, each of the first battery cells may include a first temperature sensor.

This achieves the fact that, upon reaching a dangerous limiting temperature, the first battery cells may transfer their waste heat generated during charging or discharging to the second battery cells arranged next thereto, which act as cooling bodies in the non-operating state or the state operated at low current, since it is ensured that they do not have the high temperatures of the first battery cells. A passive temperature compensation between the operated first battery cells and the second battery cells may thus take place. The limiting temperature is, in particular, determined in such a way that a damage to the first battery cells is avoided. In particular, the limiting temperature may be at least at or above, for example, 30° C. The limiting temperature may be determined as a function of different factors, such as state of charge and/or capacity of the battery cells and/or ambient temperature, or it may be a permanently predefined value for the first battery cells. The first temperature sensor may be configured to ascertain the actual temperature of the at least one first battery cell continuously or at defined time intervals. Correspondingly, the charge control unit may be configured to receive the actual temperature continuously or at defined time intervals.

According to the second aspect, the invention achieves the object by means of a motor vehicle, which includes at least one battery according to the invention.

The battery can be a vehicle electrical system battery. A vehicle electrical system battery of the motor vehicle is a battery which supplies current to the vehicle electrical system, including the electrical consumers, such as lights and electronic components of the motor vehicle. In particular, the vehicle electrical system battery is a starter battery of a motor vehicle including an internal combustion engine, which starts the internal combustion engine. For example, the vehicle electrical system battery may have a maximum voltage of 48 V. The vehicle electrical system battery is, in particular, a dual-voltage battery.

The invention also achieves the object by a method for charging a battery for a motor vehicle, including multiple first battery cells of a first material type and multiple secondary battery cells of a second material type, the first battery cells being electrically connected to each other for charging independently of the second battery cells, and the second battery cells being electrically connected to each other, and one of the multiple first battery cells being arranged in each case next to one of the multiple second battery cells in a first mounting plane, the method including the steps: (a) determining or predefining a setpoint temperature of the at least one second battery cell to be charged for starting a charging process or increasing a charging current in a charging process of the at least one second battery cell to be charged of the multiple battery cells; (b) ascertaining an actual the temperature of the at least one second battery cell to be charged; (c) charging at least one of the multiple first battery cells, which are arranged next to the at least one second battery cell to be charged, the at least one second battery cell to be charged being heated with the aid of a waste heat of the at least one charging second battery cell, which is generated during charging; and (d) starting the charging process or increasing the charging current of the charging process of the at least one second battery cell to be charged as soon as the actual temperature of the at least one second battery cell has reached the setpoint temperature.

The method according to the invention thus involves the same advantages as those described in detail with reference to the battery according to the invention.

The method can furthermore include the steps: (a) determining and predefining a limiting temperature of at least one first battery cell for blocking or aborting an operation or reducing a current during an operation of at least one second battery cell of the multiple second battery cells, which is arranged next to the at least one first battery cell; (b) ascertaining an actual temperature of the at least one first battery cell; (c) operating the at least one first battery cell, the at least one second battery cell being heated with the aid of a waste heat of the at least one first battery cell, which is generated during operation; and (d) blocking or aborting the operation or reducing the current of the operation of the at least one second battery cell when an actual temperature of the at least one first battery cell reaches the limiting temperature.

The above method steps may also achieve the object according to a separate further aspect. Namely by a method for operating a battery for a motor vehicle, including multiple first battery cells of a first material type and multiple second batteries of a second material type, the first battery cells being electrically connected to each other for charging independently of the second battery cells, and the second battery cells being electrically connected to each other, and one of the multiple first battery cells being arranged in each case next to one of the multiple second battery cells in a first mounting plane, the method including the steps: (a) determining and predefining a limiting temperature of at least one first battery cell for blocking or aborting an operation or reducing a current during an operation of at least one second battery cell of the multiple second battery cells, which is arranged next to the at least one first battery cell; (b) ascertaining an actual temperature of the at least one first battery cell; (c) operating the at least one first battery cell, the at least one second battery cell being heated with the aid of a waste heat of the at least one first battery cell, which is generated during operation; and (d) blocking or aborting the operation or reducing the current of the operation of the at least one second battery cell when an actual temperature of the at least one first battery cell reaches the limiting temperature. The operation may be a charging process or a discharging process. The current is correspondingly a charging current during a charging process or a discharging current during a discharging process.

Other measures which improve the invention result from the following description of different exemplary embodiments of the invention, which are illustrated schematically in the figures. All features and/or advantages arising from the claims, the description or the figures, including structural details and spatial arrangements, may be essential to the invention individually as well as in the different combinations.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic top view of an exemplary embodiment of a battery according to the invention;

FIG. 2 shows a schematic top view of an exemplary embodiment of a battery according to the invention;

FIG. 3 shows a front view of an exemplary embodiment of a motor vehicle according to the invention;

FIG. 4 shows a schematic diagram for an exemplary embodiment of a method according to the invention; and

FIG. 5 shows a schematic diagram for an exemplary embodiment of a method according to the invention.

### DETAILED DESCRIPTION

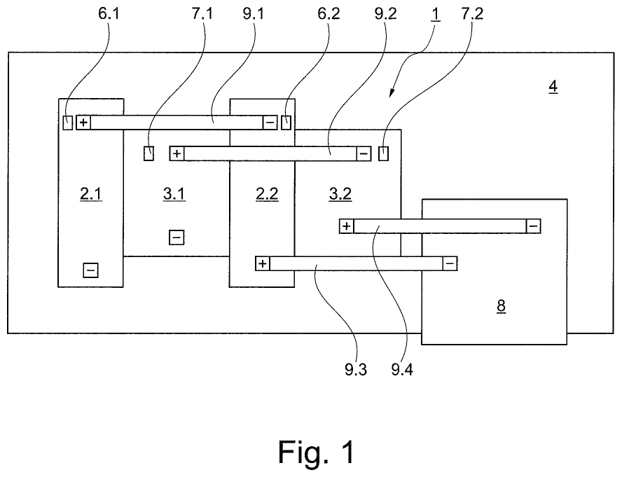

FIG. 1 shows a schematic top view of a first exemplary embodiment of a battery 1 according to the invention. Battery 1 includes two first battery cells 2.1, 2.2 of a first material type, LTO in the present case, and two second battery cells 3.1, 3.2 of a second material type, which differs from the first material type, LFP or NMC in the present case. Each of first battery cells 2.1, 2.2 is arranged next to one of second battery cells 3.1, 3.2 in a first mounting plane 4. To be precise, second battery cell 3.1 of second material type is arranged between first battery cell 2.1 and second battery cell 2.2, both of which are of the first material type, second battery cell 3.2 of second material type being arranged next to second battery cell 2.2 of the first material type. First battery cells 2.1, 2.2 are connected in series to each other and to a charge control unit 8 of battery 1 with the aid of conductor rails 9.1, 9.3. Second battery cells 3.1, 3.2 are connected in series to each other and to a charge control unit 8 of battery 1 with the aid of conductor rails 9.2, 9.4. First battery cells 2.1, 2.2 may thus be charged independently of second battery cells 3.1, 3.2. First temperature sensors 6.1, 6.2 are each arranged at first battery cells 2.1, 2.2. Second temperature sensors 7.1, 7.2 are each arranged at second battery cells 3.1, 3.2.

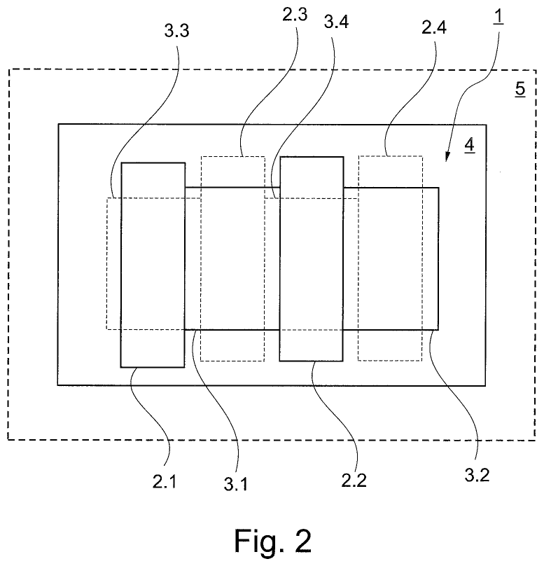

FIG. 2 shows a schematic top view of a second exemplary embodiment of a battery 1 according to the invention. Among other things, an arrangement of first battery cells 2.1, 2.2 and second battery cells 3.1, 3.2 is shown here in first mounting plane 4 of battery 1 of the first exemplary embodiment from FIG. 1, first temperature sensors 6, second temperature sensors 7, charge control unit 8 and conductor rails 9 not being shown for the sake of clarity. Unlike battery 1 from FIG. 1, battery 2 according to this second exemplary embodiment has a second mounting plane 5, including first battery cells 2.3, 2.4 and second battery cells 3.3, 3.4. Second mounting plane 5 is arranged in parallel to first mounting plane 4 and below first mounting plane 4. First battery cells 2.1, 2.2 of first mounting plane 4 abut second battery cells 3.3, 3.4 of second mounting plane 5 over a wide area, and second battery cells 3.1, 3.2 of first mounting plane 4 abut first battery cells 2.3, 2.4 of second mounting plane 5 over a wide area. A heat transfer between first battery cells 2 and second battery cells 3 in mounting planes 4, 5 themselves as well as beyond mounting planes 4, 5 is made possible thereby in each case.

Although only exemplary embodiments are shown in FIGS. 1 and 2, in which only two first battery cells of the first material type and two second battery cells of the second material type are provided with respect to the mounting plane, the invention is in no way limited thereto. Instead, in exemplary embodiments which are not shown, it is provided to provide more than two first battery cells of the first material type and more than two second battery cells of the second material type with respect to a mounting plane.

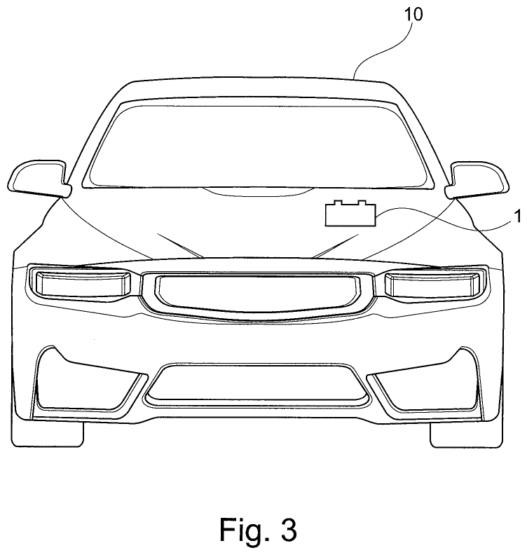

FIG. 3 shows a front view of an exemplary embodiment of a motor vehicle 10 according to the invention. Motor vehicle 10 includes a battery 1 according to the invention, which, in the present case, is designed as a vehicle electrical system battery, in particular as a starter battery.

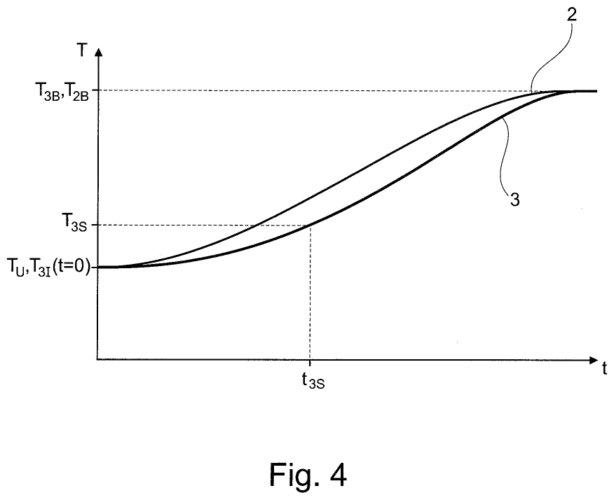

FIG. 4 is a schematic diagram for a first exemplary embodiment of a method according to the invention. FIG. 4 shows temperature T of at least one first battery cell 2 and temperature T of at least one second battery cell 3 of a battery 1 according to the invention over time t. Temperatures T may each be temperatures T of a single one of first battery cells 2 and a single one of second battery cells 3, or they may each be average values of temperatures T of multiple or all of first battery cells 2 and multiple or all of second battery cell 3. To start a charging process, a setpoint temperature T_{3S} of at least one second battery cell 3 to be charged may be determined or predefined prior to starting the charging process. Setpoint temperature T_{3S} is, in particular, above ambient temperature T_{U} and also, in particular, above 0° C. An actual temperature T_{3I} of the at least one second battery cell 3 to be charged, which is plotted here over time t, is measured continuously.

In the present case, a cold start of the battery is shown, in which both temperature T of first battery cell 2 at time point t=0 as well as measured temperature T_{3I} (t=0) of second battery cell 3 at time point t=0 are at ambient temperature T_{U}. At this point in time, at least one of multiple first battery cells 2, which are arranged next to at the least one of second battery cells 3 to be charged, begins to be charged by a charging process. The one second battery cell 3 to be charged is heated to setpoint temperature T_{3I} with the aid of a waste heat of the at least one charging second battery cell 2, which is generated during charging. A charging process of the at least one second battery cell 3 to be charged is started at setpoint time t_{3S} at which setpoint temperature T_{3S} of second battery cell 3 is reached. In addition to the waste heat of the at least one first battery cell 2, the at least one charging second battery cell 3 is now also heated by the charging process and increases to its operating temperature T_{3B}. Operating temperature T_{3B} of the at least one first battery cell 2 and operating temperature T_{3B} of the at least one second battery cell 3 are, in the present case, illustrated as identical only as an example; they may also be different. The method may also be used if the at least one second battery cell 3 is already charged with a charging current, which does not correspond to a maximum charging current, to increase the charging current at setpoint time t_{3S}, at which setpoint temperature T_{3S} of the at least one second battery cell 3 is reached.

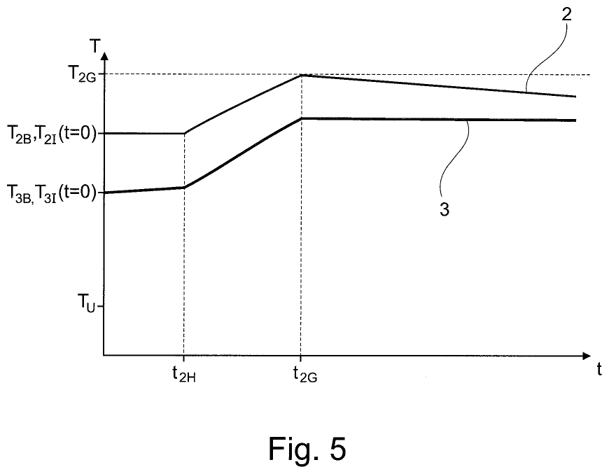

FIG. 5 is a schematic diagram for a second exemplary embodiment of a method according to the invention. FIG. 5 illustrates temperature T of at a first battery cell 2 and temperature T of a second battery cell 3 of a battery 1 according to the invention over time t. Temperatures T may each be temperatures T of a single one of first battery cells 2 and a single one of second battery cells 3, or they may each be average values of temperatures T of multiple or all of first battery cells 2 and multiple or all of second battery cell 3. A limiting temperature T_{2G} of at least one discharging first battery cell 2 for aborting a discharging process of at least one second battery cell 3 of the multiple second battery cells 3, which is arranged next to the at least one charging first battery cell 2, was determined or predefined prior to starting the charging process or during the charging process. Limiting temperature T_{2G} is, in particular, above ambient temperature T_{U}. Actual temperature T_{2I} of the at least one discharging first battery cell 2, which is plotted here over time t, is measured continuously.

In the present case, an ongoing operation in the form of a discharging process of the battery is shown, in which measured actual temperature T_{2I} (t=0) of the at least one first battery cell 2 is at an operating temperature T_{2B} at time point t=0. At time point t=0, measured actual temperature T_{3I} (t=0) of the at least one second battery cell 3 is also at an operating temperature T_{3B}, which only as an example here is lower than operating temperature T_{2B} of first battery cell 2 and which alternatively may be equal to or higher than operating temperature T_{3B} of second battery cell 3.

Actual temperature T_{2I} of first battery cell 2 increases at heating time point T_{2H}, the at least one second battery cell 3 being also heated by means of a waste heat of the at least one discharging first battery cell 2 generated during discharging. The increase in actual temperature T_{3I} of first battery cell 3 is steeper than an increase of actual temperature T_{2I} (t=0) of the at least one first battery cell 2, due to the temperature difference between first battery cell 2 and second battery cell 3. As soon as actual temperature T_{2I} of first battery cell 2 corresponds to limiting temperature T_{2G}, the discharging process of the at least one second battery cell 3 is aborted. As a result, the latter is no longer heated by the discharging action. It may thus cool down, thereby acting as a cooling body for the at least one first battery cell 2, which threatens to overheat upon exceeding limiting temperature T_{2G} . Therefore, instead of heat continuing to be generated by discharging in the at least one second battery cell 3, waste heat from first battery cell 2 is supplied to the at least one second battery cell 3.

Instead of aborting a discharging process of the at least one second battery cell 3. only the discharging current of the discharging process may be reduced to produce less heat. Likewise, if the at least one second battery cell 3 is not discharged at limiting time point T_{2G} , a discharging process of this second battery cell 3 may also be blocked to suppress a discharging process and the generation of heat. The method described above may also be used correspondingly for an operation in the form of a charging process of the at least one first battery cell 2 and the at least one second battery cell 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery for a motor vehicle, comprising:
at least two first battery cells of a first material type; and
at least two second battery cells of a second material type, which differs from the first material type, the first battery cells being electrically connected to each other for charging/discharging independently of the second battery cells, and the second battery cells being electrically connected to each other, and one of the multiple first battery cells being arranged in each case next to one or between two of the multiple second battery cells in a first mounting plane.

2. The battery according to claim 1, wherein one of the multiple first battery cells is arranged in each case next to one of the multiple second battery cells in at least one second mounting plane, one of the multiple first battery cells of the first mounting plane being arranged in each case next to one or between two of the multiple second battery cells of the second mounting plane, and one of the multiple second battery cells of the first mounting plane being arranged in each case next to one or between two of the multiple first battery cells of the second mounting plane.

3. The battery according to claim 1, wherein battery cell housings of the first battery cells and second battery cells arranged next to each other are connected to each other.

4. The battery according to claim 3, wherein the battery cell housings of the first battery cells and the second battery cells arranged next to each other are connected to each other with the aid of a heat conducting element.

5. The battery according to claim 1, wherein the first battery cells are connected separately from the second battery cells.

6. The battery according to claim 1, wherein the battery is a dual-voltage battery.

7. The battery according to claim 1, wherein the first battery cells are cold-chargeable or wherein the first material type is lithium titanate.

8. The battery according to claim 1, wherein the second battery cells are not cold-chargeable or wherein the second material type is lithium iron phosphate or lithium nickel manganese cobalt oxide.

9. The battery according to claim 1, wherein the battery includes at least one second temperature sensor for determining an actual temperature of at least one second battery cell to be charged of the multiple second battery cells, and the battery further includes a battery control unit, which is configured to:
(a) determine or predefine a setpoint temperature of the at least one second battery to be charged for starting a charging process or increasing a charging current in a charging process of the at least one second battery cell to be charged;
(b) receive the actual temperature of the at least one second battery cell to be charged from the second temperature sensor;
(c) charge/discharge at least one of the multiple first battery cells, which are arranged next to the at least one second battery cells to be charged, the at least one second battery cell to be charged being heated with the aid of the waste heat of the at least one charging/discharging first battery cell during charging/discharging; and
(d) start or increase the charging process or charging current of the charging process of the at least one second battery cell to be charged once the actual temperature when the at least one second battery cell to be charged has reached the setpoint temperature.

10. The battery according to claim 9, wherein the battery includes at least one first temperature sensor for determining an actual temperature of at least one first battery cell of the multiple first battery cells, and the charge control unit is further configured to:
(a) determine or predefine a limiting temperature of the at least one first battery cell for blocking or aborting an operation or reducing a current during an operation of at least one second battery cell, which is arranged next to the at least one first battery cell;
(b) receive the actual temperature of the at least one first battery cell from the second temperature sensor;
(c) operate the at least one first battery cell, which is arranged next to the at least one second battery cell, the at least one second battery cell being heated with the aid of the waste heat of the at least one operating first battery cell, which is generated during operation; and
(d) block or abort or reduce the operation or charging current of the at least one second battery cell when an actual temperature of the at least one operating first battery cell reaches the limiting temperature.

11. A motor vehicle comprising the battery according to claim 1.

12. The motor vehicle according to claim 11, wherein the battery is a vehicle electrical system battery.

13. A method for operating a battery for a motor vehicle that comprises at least two first battery cells of a first material type and at least two second batteries of a second material type, the first battery cells being electrically connected to each other for charging independently of the second battery cells, and the second battery cells being electrically connected to each other, and one of the first battery cells being arranged in each case next to one of the second battery cells in a first mounting plane, the method comprising:
determining or predefining a setpoint temperature of the at least one second battery to be charged for starting a charging process or increasing a charging current in a charging process of the at least one second battery cell to be charged of the multiple second battery cells;
ascertaining an actual temperature of the at least one second battery cell to be charged;
charging or discharging at least one of the multiple first battery cells, which are arranged next to the at least one second battery cells to be charged, the at least one second battery cell to be charged being heated with the aid of a waste heat of the at least one charging second battery cell, which is generated during charging; and
starting the charging process or increasing the charging current of the charging process of the at least one second battery cell to be charged once an actual temperature of the at least one second battery cell to be charged corresponds to the setpoint temperature.

14. The method according to claim 13, further comprising:
determining or setting a limiting temperature of the at least one first battery cell for blocking or aborting an operation or reducing a current during an operation of at least one second battery cell of the multiple second battery cells, which is arranged next to the at least one first battery cell;
ascertaining an actual temperature of the at least one first battery cell;
operating the at least one first battery cell, the at least one second battery cell being heated with the aid of a waste heat of the at least one operating first battery cell, which is generated during operation; and
blocking or aborting the operation or reducing the current of the operation of the at least one second battery cell when an actual temperature of the at least one charging first battery cell reaches the limiting temperature.
